(19) United States
(12) Patent Application Publication
(10) Pub. No.: US 2005/0149400 A1
(43) Pub. Date: Jul. 7, 2005

(54) Product search locator

(76) Inventor: Eddie C. Watkins, Boston, MA (US)

Correspondence Address: IRVING M. WEINER,;WEINER & BURT, P.C., 635 N. US-23, P.O. BOX 186, HARRISVILLE, MI, 48740, US

(21) Appl. No.: 11/015,977

(22) Filed: Dec. 17, 2004

Related U.S. Application Data
(60) Provisional application No. 60/534,262, filed on Jan. 5, 2004.

(51) Int. Cl. G06F 17/60

(52) U.S. Cl. 705/14

(57) ABSTRACT

A combined consumer product search directory and frequent shopper discount machine having a scanner window which is activated by a frequent shopper discount card having appropriate barcode information therein. The system can generate a discount coupon at the checkout register for that customer.

The present application claims priority from and is a continuation-in-part of U.S. Provisional Patent Application Ser. No. 60/534,262 filed Jan. 5, 2004, the entire contents of which are incorporated herein by reference thereto.

The present invention relates generally to a new and useful product search locator.

More particularly, the present invention relates to a novel and useful consumer product search directory combined with a frequent shopper command center.

### BACKGROUND OF THE INVENTION

It is a frequent occurrence that a shopper in a store cannot readily locate a desired product without walking up and down many aisles in the store. Many times, the customer gives up and leaves the store without purchasing a product.

One of the purposes of the present invention is to help the customer find what he or she wants with great rapidity and ease.

The prior, but not necessarily relevant, art is exemplified by Klapka U.S. Pat. No. 5,915,007 entitled “METHOD AND SYSTEM FOR USING A FREQUENT SHOPPER CARD AS A PHONE CALLING CARD”; Sloan U.S. Pat. No. 5,918,211 entitled “METHOD AND APPARATUS FOR PROMOTING PRODUCTS AND INFLUENCING CONSUMER PURCHASING DECISIONS AT THE POINT-OF-PURCHASE”; and Walker et al. U.S. Pat. No. 6,327,573 entitled “MULTIPLE PARTY REWARD SYSTEM USING SINGLE ACCOUNT”.

It is a desideratum of the present invention to avoid the animadversions of the conventional systems and techniques being employed in stores at the present time.

### SUMMARY OF THE INVENTION

The present invention provides a consumer product search directory system, comprising, in combination: a product search locator apparatus including user-friendly product search software, a computer, a display monitor, and first means for a consumer to enter in the name or type of product which said consumer desires to locate; a frequent shopper command center machine operably interconnected with said product search locator apparatus; and said frequent shopper command center machine including a device for scanning a discount card of a frequent shopper.

The present invention also provides a new and useful combined product consumer product search directory and frequent shopper discount card system comprising: a frequent shopper command center machine linked to a main database server; the command center machine includes a keyboard, and an optional track mouse ball, a voice recognition system, a voice-activated recognition system hand phone, a touch screen display, and a scanner window for scanning a frequent shopper's discount card; a search for a product can be initiated by keyboard typing, portable non-private voice recognition system, private telephone voice recognition system, or touch screen method.

It is a primary object of the present invention to provide a combined consumer product search directory and frequent shopper discount unit at each entrance of a store.

Another object of the present invention is to provide a system whereby a customer entering a store can indicate the product the customer is searching for, and the location of the product can be conveyed to the customer by way of a screen display or an audio output.

Another object of the present invention is to provide a combined consumer product search directory and frequent shopper discount unit as described hereinabove wherein the system can generate a discount coupon at the checkout register for that customer.

Another object of the present invention is to provide a combined consumer product search directory and frequent shopper discount card machine which is activated by a voice-activated recognition system.

A further object of the present invention is to provide a combined consumer product search directory and frequent shopper discount card machine having a scanner window which may be activated by a frequent shopper discount card with appropriate bar code information therein.

The present invention possesses many advantages and features which will become more apparent to those persons skilled in this particular area of technology and to other persons when reading the detailed description of some exemplary preferred embodiments of the present invention as set forth hereinbelow in conjunction with the accompanying drawings.

### BRIEF DESCRIPTION OF THE DRAWINGS

FIG. 1 is a perspective illustration of a consumer product search directory combined with a frequent shopper discount card machine in accordance with several preferred embodiments of the present invention.

FIG. 2 is an exemplary view of a display screen showing the location for a desired product.

### DETAILED DESCRIPTION OF SOME PREFERRED EMBODIMENTS

With reference to the drawings, there is shown an information main database server 10 which keeps track of the location of various products in the store, customer searches, products which are on sale, etc.

In a first embodiment, a cable 11 links the main database server 10 to a combined consumer product search directory and frequent shopper discount card machine 12. In the machine 12, the cable 11 is linked to an internal computer (not shown). The machine 12 also includes a keyboard 13, an optional track mouse ball 14, a touch screen display 15, a speaker 16, an internal voice recognition system, a built-in microphone 17 for the voice-recognition system, a voice-activated recognition system hand-held phone 18, and a card scanner window 19, all of which are operably interconnected with the internal computer in the machine 12, and to the main database server 10 through the cable 11.

A customer desiring to ascertain the location of a product, for example, soap, can input the inquiry in various ways. For example, the customer can interact with the consumer product search directory machine 12 by: keyboard 13 typing; voice-recognition speaking through the hand-held telephone 18 with privacy; leaving the hand-held telephone 18 down on the receiver button 20 and speaking into the voice recognition system by way of the microphone 17 with no privacy; or by use of the touch screen 15.

The touch screen display 15 can have various portions, such as a menu display portion 21, a voice display portion 22, a keyboard display portion 23 and a search display portion 24.

If the customer inputs the query by keyboard typing, such as inquiring for the location of soap, the display would indicate that the soap product is located, for example in Aisle 4, Shelf 2, as represented by the display illustrated in FIG. 2.

Alternatively, the customer may lift the voice-recognition telephone handset 18 and verbally input the query. This gives the customer more privacy.

As a further alternative, the customer may leave the telephone handset 18 down on the receiver button 20, and merely speak into the voice recognition system microphone 17 with no privacy.

As a further alternative, the customer can input the product query through use of the touch screen display 15 using the menu and search portions 21, 22, 23 and 24 on the display.

The present invention envisions the option of having the display 15 use store advertising for products on sale, and the like, when the system is not being used by a customer to find the location of a particular product. This can be done in the nature of a screen saver system.

The machine 12 in accordance with the present invention can be used as not only a consumer product search directory product, but also as a frequent shopper discount card display system. The frequent shopper display aspects of the invention will now be described.

If the frequent shopper customer walks up to the machine 12 and moves the customer's frequent shopper bar coded card 25 in the vicinity of the scanner window 19, this serves to bring the machine 12 out of its sleep mode. The machine 12 then will respond with a personalized greeting for that particular customer.

The machine 12 will then log into the database server 10 if needed to generate frequent shopper discount coupons at the cashier ring-out counter if the frequent shopper consumer is eligible for discounts.

The first embodiment of the present invention contemplates having the main database server 10 located in a computer room at some remote location which will be available for uploading more store product locations, etc.

Preferably, but not necessarily, the system can include a built-in printer 29 for supplying the customer with a list of the desired products and the locations of each such product, frequent shopper consumer discounts and/or other information, advertisements, etc.

In accordance with a second embodiment of the present invention, the cable 11 may be eliminated by providing the machine 12 with a wireless transmit-receive unit 30 which can be linked by appropriate frequency to a wireless transmit-receive unit 31 which is located at and operably interconnected with the database server 10.

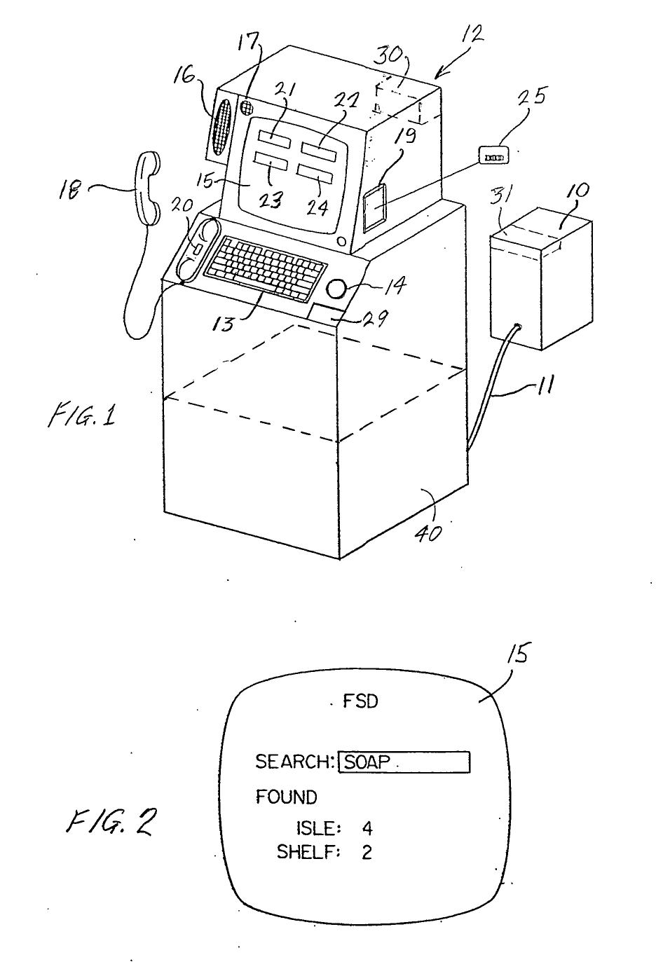

In accordance with a third embodiment of the present invention, the cable 11 may be eliminated and the machine 12 can be provided with a built-in server 40 which is shown in FIG. 1 partially in phantom line. Preferably, but not necessarily, the server 40 can be wirelessly interconnected with a remote main server 10.

There has been illustrated in the accompanying drawings and described hereinbaove several unique and novel preferred embodiment of the present invention which can be constructed in several different configurations.

It should be understood that many changes, modifications, variations, and other uses and applications will become apparent to those persons skilled in this particular area of technology and to other persons after having been exposed to the present patent application with its accompanying patent drawings.

Any and all such changes, modifications, variations and other uses and applications which do not depart from the spirit and scope of the present invention are therefore covered by and embraced within the present invention and the patent claims.

1. A consumer product search directory system, comprising, in combination:
a product search locator apparatus including user-friendly product search software, computer, a display monitor, and first means for a consumer to enter in the name or type of product which said consumer desires to locate;
a frequent shopper command center machine operably interconnected with said product search locator apparatus; and
said frequent shopper command center machine including a device for scanning a discount card of a frequent shopper.

2. The system according to claim 1, wherein said first means includes a keyboard.

3. The system according to claim 1, wherein:
said first means includes a voice recognition system.

4. The system according to claim 2, wherein:
said first means includes a voice recognition system.

5. The system according to claim 1, including:
a main database server; and
second means for linking said computer to said main database server.

6. The system according to claim 2, including:
a main database server; and
second means for linking said computer to said main database server.

7. The system according to claim 3, including:
a main database server; and
second means for linking said computer to said main database server.

8. The system according to claim 4, including:
a main database server; and
second means for linking said computer to said main database server.

9. The system according to claim 5, wherein:
said second means comprises a wireless system.

10. The system according to claim 6, wherein:
said second means comprises a wireless system.

11. The system according to claim 7, wherein:
said second means comprises a wireless system.

12. The system according to claim 8, wherein:
said second means comprises a wireless system.

13. The system according to claim 1, wherein:
said product search locator apparatus and said frequent shopper discount card machine are activated by a voice-activated voice recognition system.

14. The system according to claim 2, wherein:
said product search locator apparatus and said frequent shopper discount card machine are activated by a voice-activated voice recognition system.

15. The system according to claim 3, wherein:
said product search locator apparatus and said frequent shopper discount card machine are activated by a voice-activated voice recognition system.

16. The system according to claim 4, wherein:
said product search locator apparatus and said frequent shopper discount card machine are activated by a voice-activated voice recognition system.

17. The system according to claim 5, wherein:
said product search locator apparatus and said frequent shopper discount card machine are activated by a voice-activated voice recognition system.

18. The system according to claim 6, wherein:
said product search locator apparatus and said frequent shopper discount card machine are activated by a voice-activated voice recognition system.

19. The system according to claim 7, wherein:
said product search locator apparatus and said frequent shopper discount card machine are activated by a voice-activated voice recognition system.

20. The system according to claim 12, wherein:
said product search locator apparatus and said frequent shopper discount card machine are activated by a voice-activated voice recognition system.
